(19) United States
(12) Patent Application Publication
(10) Pub. No.: US 2010/0155655 A1
(43) Pub. Date: Jun. 24, 2010

(54) POLISHING COMPOSITION

(76) Inventors: Yoshiyuki Matsumura, Kyoto (JP); Hiroshi Nitta, Kyoto (JP)

Correspondence Address: HARNESS, DICKEY & PIERCE, P.L.C., P.O. BOX 8910, RESTON, VA, 20195, US

(21) Appl. No.: 12/452,798

(22) PCT Filed: Jul. 24, 2008
(86) PCT No.: PCT/JP2008/063322

§ 371 Date: Feb. 22, 2010

(30) Foreign Application Priority Data
Jul. 24, 2007 (JP) 2007-192666

(51) Int. Cl. C09K 13/00

(52) U.S. Cl. 252/79.1

(57) ABSTRACT

An object of one embodiment of the present invention is to provide a polishing composition that can achieve high polishing rate and as well can improve flatness. A polishing composition of an embodiment of the invention is a polishing composition suitable for a metal film, in particular, a copper film, and contains a basic compound containing an ammonium group, alkylbenzene sulfonate having an alkyl group with carbon number of from 9 to 18, and hydrogen peroxide, the remainder being water. Ammonium hydroxide can be used as the basic compound, and dodecylbenzene sulfonate or the like can be used as the alykbenzene sulfonate.

### TECHNICAL FIELD

The present invention relates to a polishing composition for polishing a metal film, in particular, for polishing a copper film.

### BACKGROUND ART

To meet the demands to high integration and reduction in size of semiconductor integrated circuit (LSI), a technique called system in package (SIP) in which a plurality of semiconductors having various functions such as memory function and logic function are three-dimensionally mounted on one substrate is developed. With this technique, the number of wirings and the number of bumps, formed on a substrate are increased, and a diameter of each wiring is decreased. As a result, formation of fine wiring becomes difficult in build-up method and mechanical polishing of the conventional methods.

For this reason, copper, copper alloy and the like having electric resistance lower than that of aluminum are utilized in place of aluminum conventionally used as a wiring material. However, due to the properties of copper, copper is difficult to form wiring by dry etching as in aluminum, and for this reason, a wiring formation method called a damascene process is established.

According to a damascene process used in a semiconductor process, for example, wirings and plugs are formed on the surface of a substrate by forming grooves corresponding to wiring patterns to be formed and holes corresponding to plugs (electrically connecting portions to wirings in the inside of a substrate) to be formed on the surface of a substrate coated with a silicon dioxide film, forming a barrier metal film (insulating film) comprising titanium, titanium nitride, tantalum, tantalum nitride, tungsten or the like on an inner wall surface of the grooves and holes, coating the whole surface of the substrate with a copper film by plating or the like to embed copper in the grooves and holes, and removing excess copper film on a region other than the grooves and holes by chemical mechanical polishing (CMP).

The damascene process and CMP can be applied to SIP in a similar manner. However, because a thickness of a metal film such as a copper film coated on the surface of a substrate ranges 5 μm or more, there are concerns regarding increase in processing time by CMP and great deterioration of productivity.

It is considered in CMP to a metal layer that polishing proceeds by a process that compounds formed on the surface of a metal by chemical reaction in an acidic region are polished by polishing abrasive grains. From this, slurry used in CMP to a metal layer is generally acidic.

However, acidic slurry has the tendency that polishing rate is decreased as the number of layers to be polished is increased. Furthermore, when an alkaline washing liquid for removing abrasive grains is used after polishing, abrasive grains become massed together by pH shock. For this reason, alkaline slurry enabling high speed polishing is desired in place of acidic slurry.

A polishing composition for CMP containing polishing abrasive grains, ammonium persulfate, oxalic acid, benzotriazol, dodecylbenzene sulfonic acid and/or a salt of dodecylbenzene sulfonic acid, polyvinyl pyrrolidone, and pH regulator that is a water-soluble basic compound is disclosed as slurry used in alkaline state of pH 8 to 12 (see Japanese Unexamined Patent Publication JP-A 2007-13059).

It is disclosed that a polishing composition having sufficient copper polishing rate and large difference of polishing rate to a barrier layer can be realized by such a constitution.

It is described that the polishing composition described in JP-A 2007-13059 has sufficient copper polishing rate. However, as described in Examples 1 to 3, copper polishing rate is in a range of about 0.210 to 0.260 μm, and is less than 1 μm/min. Furthermore, Comparative Example 4 uses hydrogen peroxide, but polishing rate is not improved at all.

The inventors prepared a polishing composition to which ammonium persulfate was added as a component by which improvement of polishing rate is best-expected, in an amount of 10% by mass that is the maximum amount of the preferred range in the composition described in JP-A 2007-13059, and measured polishing rate. As a result, polishing rate was 0.9 μm/min (load 210 hPa) in the case of containing dodecylbenzene sulfonic acid, and polishing rate was 3.0 μm/min (load 210 hPa) in the case of not containing dodecylbenzene sulfonic acid.

Thus, in the conventional polishing composition, sufficient copper polishing rate is not yet obtained, and flatness is not improved. For this reason, a polishing composition that can achieve higher polishing rate and can improve flatness is desired.

### DISCLOSURE OF INVENTION

An object of the invention is to provide a polishing composition that can achieve high polishing rate and as well can improve flatness.

The invention relates to a polishing composition comprising a basic compound containing an ammonium group, alkylbenzene sulfonate having an alkyl group with carbon number of from 9 to 18, and hydrogen peroxide.

In the invention, it is preferable that the polishing composition has a pH of from 8 to 12.

In the invention, it is preferable that the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate.

In the invention, it is preferable that carbon number of the alkyl group in the alkylbenzene sulfonate is from 10 to 16.

In the invention, it is preferable that the polishing composition comprises abrasive grains.

In the invention, it is preferable that the polishing composition comprises an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid.

### BRIEF DESCRIPTION OF DRAWINGS

Objects, features, and advantages of the invention will be more explicit from the following detailed description taken with reference to the drawing, wherein:

FIG. 1 is a graph showing influence of the content of an amine salt of dodecylbenzene sulfonic acid to polishing rate; and

FIG. 2 is a graph showing polishing rate ratios of Examples 2 to 4 and Comparative Examples 2 and 3.

### BEST MODE FOR CARRYING OUT THE INVENTION

Now referring to the drawings, preferred embodiments of the invention are described below.

The polishing composition of the invention is a polishing composition suitable for a metal film, in particular, a copper (Cu) film, and contains a basic compound containing an ammonium group, alkylbenzene sulfonate having an alkyl group with carbon number of from 9 to 18, and hydrogen peroxide, the remainder being water. By containing them, a polishing composition that can achieve high polishing rate and can improve flatness can be realized.

The polishing composition of the invention is described in detail below.

Examples of the basic compound containing an ammonium group contained in the polishing composition of the invention include ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate. Among them, ammonium hydroxide is preferred.

The content of the basic compound containing an ammonium group in the polishing composition of the invention is from 1 to 20% by weight, and preferably from 2 to 14% by weight, of the total amount of the polishing composition. Where the content of the basic compound containing an ammonium group is less than 1% by weight, sufficient polishing rate is not obtained. In the case where the content exceeds 20% by weight, pH control becomes difficult, or an organic acid dissolved precipitates. The polishing rate becomes nearly maximum when the content is 20% by weight, and even though the basic compound is added in an amount exceeding 20% by weight, improvement in polishing rate is not desired. For this reason, the upper limit is 20% by weight from the standpoint of costs.

The alkylbenzene sulfonate contained in the polishing composition of the invention is preferably that the alkyl group has carbon number of from 9 to 18. Specifically, one or two or more of the following can be used: nonyl benzene sulfonate (C9), decyl benzene sulfonate (C10), undecyl benzene sulfonate (C11), dodecylbenzene sulfonate (C12), tridecyl benzene sulfonate (C13), tetradecyl benzene sulfonate (C14), pentadecyl benzene sulfonate (C15), hexadecyl benzene sulfonate (C16), heptadecyl benzene sulfonate (C17) and octadecyl benzene sulfonate (C18). Among them, dodecylbenzene sulfonate and mixtures of salts having carbon number of from 10 to 16 are more preferred.

As the salt, sodium salt, potassium salt, amine salt and the like are preferred, and sodium salt and amine salt are more preferred.

In an alkaline region, an ammonium group (NH₄⁺) acts as a complexing agent and an oxidizing agent to Cu, and reacts with Cu to form a complex as shown in the formula (1).

Cu+4NH₄⁺→[Cu(NH₃)₄]²⁺ (1)

In CMP of a copper film, it is considered that the Tetraamine copper complex is removed by contacting with a polishing pad, and polishing is accelerated.

Furthermore, when alkylbenzene sulfonate having an alkyl group with carbon number of from 9 to 18 is present in a polishing composition, the alkylbenzene sulfonate coordinates so as to surround the tetraamine copper complex, and a kind of a protective film is formed.

Etching of copper is suppressed by the protective film, and suppression of dishing or the like and improvement in level-difference elimination properties are realized. Furthermore, the protective film is difficult to be removed by polishing under low load, and suppresses polishing rate under low load. On the other hand, the protective film is easily removed when load is increased, and polishing acceleration effect by the tetramine copper complex is exhibited.

Thus, by decreasing polishing rate in low load and increasing polishing rate in high load, load dependency is exhibited, level-difference elimination properties in a wiring part are improved, and flatness can be improved.

Regarding the carbon number of the alkylbenzene sulfonate, in the case where it has an alkyl group having carbon number of 8 or less, polishing rate is increased even under low load (for example, 5 hPa), and flatness is deteriorated. In the case where it has an alkyl group having carbon number of 19 or more, the alkylbenzene sulfonate adheres to the surface of a copper film, and tetraamine copper complex is difficult to be formed. As a result, polishing rate is decreased and the alkylbenzene sulfonate is difficult to coordinate to the tetraamine copper complex, thereby a protective film is not formed. Consequently, polishing rate under low load is increased.

The content of the alkylbenzene sulfonate in the polishing composition of the invention is from 0.1 to 2% by weight, and more preferably from 0.25 to 1% by weight, of the total amount of the polishing composition. Polishing rate is decreased as the content of the alkylbenzene sulfonate is increased. If correlation between the content of the alkylbenzene sulfonate and the polishing rate has linearity, optimization of a polishing composition becomes easy, and it is easy to handle as a polishing composition, and is excellent. Where the alkylbenzene sulfonate is less than 0.1% by weight, correlation between the content and the polishing rate collapses, which is not preferred. On the other hand, where the content exceeds 2% by weight, sufficient polishing rate is not obtained.

Furthermore, when the content of the alkylbenzene sulfonate is in more preferred range of from 0.25 to 1% by weight, polishing rate under low load is suppressed low, and polishing rate under high load can be sufficiently increased.

The invention can realize higher polishing rate by containing hydrogen peroxide. The content of hydrogen peroxide in the polishing composition of the invention is from 0.1 to 5.0% by weight, and preferably from 0.5 to 4.0% by weight, of the total amount of the polishing composition. Where the content of hydrogen peroxide is less than 0.1% by weight, sufficient effect is not obtained, and where the content exceeds 5.0% by weight, oxidation reaction with cupper or the like is excessive, and control of polishing becomes difficult, which is not preferred.

As an oxidizing agent, other than hydrogen peroxide, for example, hydrogen peroxide, sulfuric acid, hydrochloric acid, nitric acid, iodic acid, iodate (such as potassium iodate), periodical acid, periodate (such as potassium periodate), persulfate, hypochlorous acid, ozone water and the like can be used. As the oxidizing agent, they can be used each alone or two or more thereof can be used in combination.

The organic acid contained in the polishing composition of the invention is one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid. Among them, tartaric acid is preferred.

The content of the organic acid in the polishing composition of the invention is from 1.0 to 10% by weight, and preferably from 3.0 to 8.0% by weight, of the total amount of the polishing composition. Where the content of the amino acid is less than 1.0% by weight and exceeds 10% by weight, improvement in polishing rate is not almost seen.

In the polishing composition of the invention, its pH is alkaline and is sufficient to be a range of from 8 to 12. The pH is preferably from 9 to 10.5.

In the polishing composition of the invention, sufficient effect is exhibited even though abrasive grains are not contained. However, abrasive grains may be contained so long as the preferred characteristics of the invention are not impaired. Polishing rate can be improved by containing abrasive grains.

As the abrasive grains, materials conventionally used in this field can be used, and examples thereof include colloidal silica, fumed silica, colloidal alumina, fumed alumina and ceria.

The content of the abrasive grains in the polishing composition of the invention is from 0.01 to 10% by weight of the total amount of the polishing composition.

The polishing composition of the invention may further contains pH regulator and the like in addition to the above components.

As to the pH regulator, examples of an acidic component include nitric acid (HNO₃), sulfuric acid, hydrochloric acid, acetic acid and lactic acid, and examples of an alkaline component include potassium hydroxide (KOH), calcium hydroxide and lithium hydroxide.

The polishing composition of the invention can contain one or two or more of various additives conventionally used in the polishing composition in this field so long as the preferred characteristics thereof are not impaired.

Water used in the polishing composition of the invention is not particularly limited. However, considering use in a production step of, for example, a semiconductor device, pure water, ultrapure water, ion-exchanged water, distilled water, and the like are preferred.

Method for producing the polishing composition of the invention is described below.

In the case where the polishing composition does not contain abrasive grains and consists of a basic compound containing an ammonium group, alkylbenzene sulfonate, hydrogen peroxide and other water-soluble additives, those compounds are used in appropriate amounts, and water is used in an amount to make the total amount 100% by weight. The polishing composition can be produced by uniformly dissolving or dispersing those components in water so as to become the desired pH according to the general procedures.

The polishing composition of the invention can preferably be used in polishing of various metal films in LSI production process, and can, in particular, preferably used as a polishing slurry for polishing a metal film in CMP process in forming metal wiring by a damascene process. More specifically, the polishing composition of the invention can highly preferably be used as a metal film polishing slurry in forming, for example, metal wiring for stacking LSI chip in SIP, and upper layer copper wiring of semiconductor device (for the formation of the copper wiring, it is necessary to polish a copper film having a film thickness of 5 μm or more). In other words, the polishing composition of the invention is particularly useful as a metal film polishing composition for CMP process by a damascene process.

Examples of the metal film to be polished here include metal films such as copper and copper alloy to be coated on the surface of a substrate, tantalum, tantalum nitride, titanium, titanium nitride, and tungsten. Among them, a metal film of copper is particularly preferred.

### EXAMPLES

Examples and Comparative Examples of the invention are described below.

Examples and Comparative Examples of the invention were prepared with the following compositions, respectively.

### Example 1

| | | |
|---|---|---|
| Ammonia | 5% | by weight |
| Amine salt of dodecylbenzene sulfonic acid | 0.5% | by weight |
| Hydrogen peroxide | 2% | by weight |

| | |
|---|---|
| Water | Remainder |

### Comparative Example 1

| | |
|---|---|
| Ammonia | 5% by weight |
| Hydrogen peroxide | 2% by weight |
| Water | Remainder |

A pH of Example 1 and Comparative Example 1 was adjusted to 10 by adding an appropriate amount of pH regulator (sulfuric acid).

Comparative Example has the same composition as Example 1 except for not containing amine salt of dodecylbenzene sulfonic acid.

Using the above Example 1 and Comparative Example 1, polishing rate was measured. Polishing conditions and evaluation method of polishing rate are shown below.

### [Polishing Conditions]

Substrate to be polished: 100-mm diameter copper-plated substrate

Polishing apparatus: ECOMET 4 (manufactured by BUEHLER)

Polishing pad: MH pad (manufactured by Nitta Haas Incorporated)

Rotation rate of polishing platen: 100 rpm

Rotation rate of carrier: 65 rpm

Polishing load surface pressure: 5,140 hPa

Flow rate of semiconductor polishing composition: 30 ml/min

Polishing time: 60 seconds

### [Polishing Rate]

The polishing rate is represented by a thickness (μm/min) of a wafer removed by polishing per unit time. The thickness of a wafer removed by polishing was calculated by measuring weight loss of the weight of a wafer and dividing the weight loss by an area of polished surface of a wafer. The results are shown in Table 1.

TABLE 1

| | Load | Polishing rate | Polishing rate |
|---|---|---|---|
| | [hPa] | [μm/min] | ratio |
| Example 1 | 5 | 1.0 | 4.1 |
| | 140 | 4.1 | |
| Comparative Example 1 | 5 | 5.5 | 1.4 |
| | 140 | 7.5 | |

As seen from the results shown in Table 1, Example 1 was that when the polishing load was as low as 5 hPa, polishing rate was not increased, and when the load was increased to 140 hPa, the polishing rate was increased. Comparative Example 1 was that polishing rate became high even though polishing load was low, and even though the load was increased to 140 hPa, the polishing rate was not increased so much.

### [Alkylbenzene Sulfonate Content]

To investigate the preferred content of alkylbenzene sulfonate, the concentration of dodecylbenzene sulfonate was changed as follows, and polishing rate was measured.

### Investigation Example 1

| | | |
|---|---|---|
| Ammonia | 5% | by weight |
| Amine salt of dodecylbenzene sulfonic acid | 0-2% | by weight |
| Hydrogen peroxide | 2% | by weight |
| Organic acid: Tartaric acid | 5% | by weight |

| | |
|---|---|
| pH regulator: potassium hydroxide | Appropriate amount |
| Water | Remainder |

A pH thereof was adjusted to 10 by adding an appropriate amount of pH regulator (potassium hydroxide).

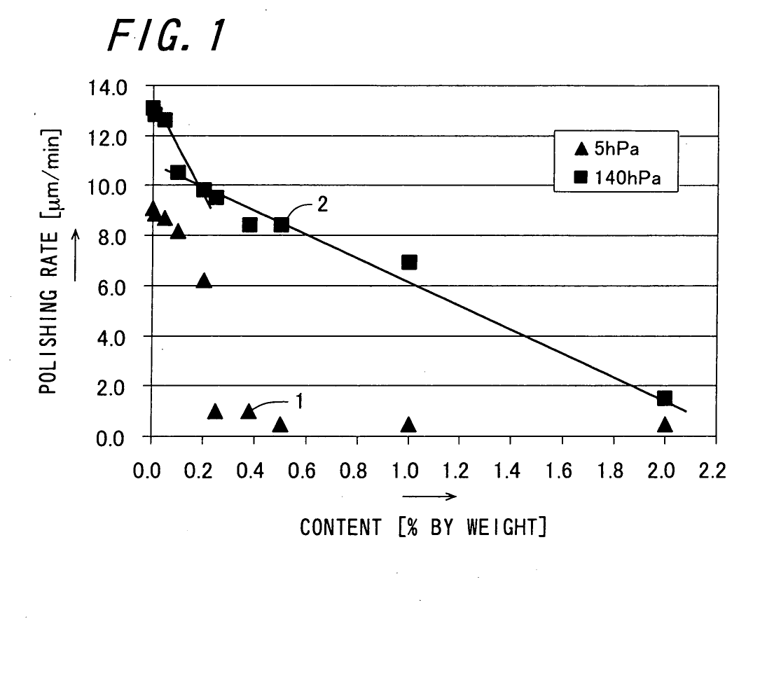

The polishing conditions and the evaluation method of polishing rate are the same as above. The results are shown in FIG. 1.

FIG. 1 is a graph showing influence of the content of an amine salt of dodecylbenzene sulfonic acid to polishing rate.

The horizontal axis shows the content [% by weight] of an amine salt of dodecylbenzene sulfonic acid, and the vertical axis shows polishing rate [μm/min]. Plot 1 shows the case where load is 5 hPa, and plot 2 shows the case where load is 140 hPa. Regarding the plot 2, an approximate line of the measurement values when dodecylbenzene sulfonate is less than 0.1% by weight, and an approximate line of the measurement values when dodecylbenzene sulfonate is 0.1% by weight or more, are shown.

As seen from FIG. 1, when the load is 140 hPa, gradients of the approximate lines greatly differ between less than 0.1% by weight and 0.1% by weight or more of the dodecylbenzene sulfonate. In less than 0.1% by weight, change of polishing rate to the content is rapid, and polishing rate is liable to become unstable, and correlativity between the content and the polishing rate collapses, which is not preferred. When the content exceeds 2% by weight, sufficient polishing rate is not obtained.

Furthermore, when the content of dodecylbenzene sulfonate is 0.25% by weight or more, polishing rate under low load is suppressed low, and polishing rate under high load is sufficiently high. In short, polishing rate ratio was greatly increased.

By further containing an organic acid, the polishing composition of the invention can further improve polishing rate.

Further investigations were conducted below regarding the constitution containing tartaric acid as an organic acid.

### Example 2

| | | |
|---|---|---|
| Ammonia | 5% | by weight |
| Amine salt of dodecylbenzene sulfonic acid | 0.5% | by weight |
| Hydrogen peroxide | 2% | by weight |
| Organic acid: tartaric acid | 5% | by weight |

| | |
|---|---|
| Water | Remainder |

### Example 3

| | | |
|---|---|---|
| Abrasive grains: colloidal silica | 3% | by weight |
| Ammonia | 5% | by weight |
| Amine salt of dodecylbenzene sulfonic acid | 0.5% | by weight |
| Hydrogen peroxide | 2% | by weight |
| Organic acid: tartaric acid | 5% | by weight |

| | |
|---|---|
| Water | Remainder |

### Example 4

| | | |
|---|---|---|
| Abrasive grains: colloidal silica | 3% | by weight |
| Ammonia | 5% | by weight |
| Na salt of C10-16 alkylbenzene sulfonic acid | 0.5% | by weight |
| Hydrogen peroxide | 2% | by weight |
| Organic acid: tartaric acid | 5% | by weight |

| | |
|---|---|
| Water | Remainder |

Na salt of C10-16 alkylbenzene sulfonic acid is a mixture of Na salts of alkylbenzene sulfonic acids having carbon number of from 10 to 16.

### Comparative Example 2

| | |
|---|---|
| Ammonia | 5% by weight |
| Hydrogen peroxide | 2% by weight |
| Organic acid: tartaric acid | 5% by weight |
| Water | Remainder |

### Comparative Example 3

| | | |
|---|---|---|
| Ammonia | 5% | by weight |
| Amine salt of octyl benzene sulfonic acid | 0.5% | by weight |
| Hydrogen peroxide | 2% | by weight |
| Organic acid: tartaric acid | 5% | by weight |

| | |
|---|---|
| Water | Remainder |

A pH of Examples 2 to 4 and Comparative Examples 2 and 3 was adjusted to 10 by adding an appropriate amount of pH regulator (potassium hydroxide).

Comparative Example 2 is the same composition as Example 2, except for not containing an amine salt of dodecylbenzene sulfonic acid. Comparative Example 3 is the same composition as Example 2, except for containing an amine salt of octylbenzene sulfonic acid in place of an amine salt of dodecylbenzene sulfonic acid.

Example 3 is the same composition as Example 2, except for containing colloidal silica as abrasive grains, and Example 4 is the same composition as Example 3, except for containing a mixture of Na salts of alkylbenzene sulfonic acids having carbon number of from 10 to 16 in place of an amine salt of dodecylbenzene sulfonic acid.

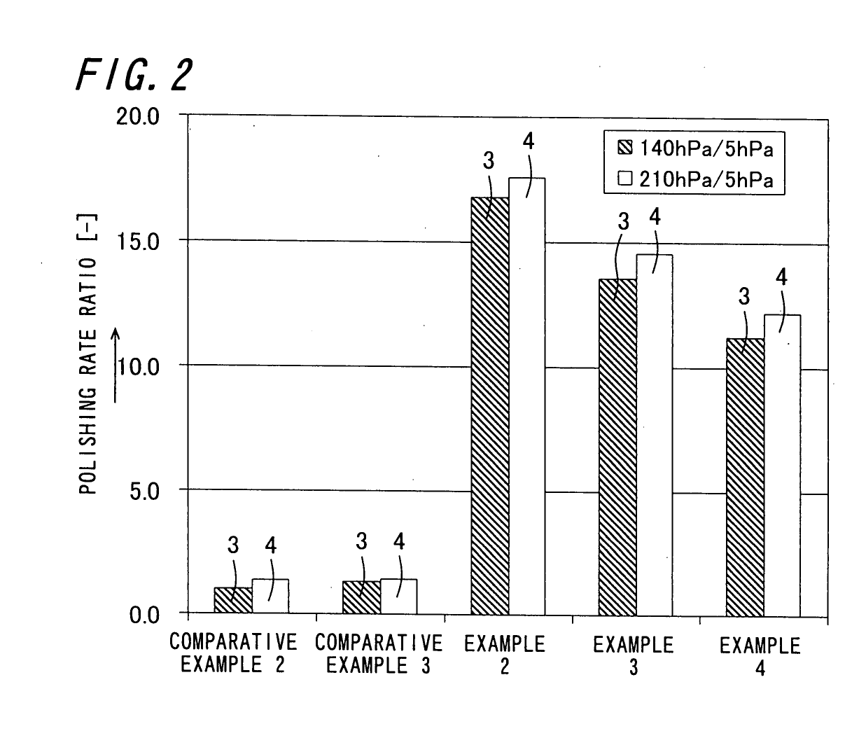

Using the above Examples 2 to 4 and Comparative Examples 2 and 3, polishing rate was measured. The polishing conditions and the evaluation method of polishing rate are the same as above. The results are shown in Table 2 and FIG. 2.

TABLE 2

| | Polishing rate [μm/min] | | | Polishing rate ratio [—] | |
|---|---|---|---|---|---|
| | 5 hPa | 140 hPa | 210 hPa | 140 hPa/5 hPa | 210 hPa/5 hPa |
| Example 2 | 0.5 | 8.4 | 8.8 | 16.8 | 17.6 |
| Example 3 | 0.7 | 9.5 | 10.2 | 13.6 | 14.6 |
| Example 4 | 0.9 | 10.1 | 11.0 | 11.2 | 12.2 |
| Comparative Example 2 | 9.0 | 9.5 | 12.5 | 1.1 | 1.4 |
| Comparative Example 3 | 7.0 | 9.5 | 10.1 | 1.4 | 1.4 |

As seen from Table 2, in Comparative Examples 2 and 3, polishing rate is high even under the condition that load is as low as 5 hPa, and there was almost no difference to the conditions that load is 140 and 210 hPa. Contrary to this, it was found that in Examples 2 to 4, polishing rate was suppressed very low under the condition that load is 5 hPa, and polishing rate was improved under the conditions that load is 140 and 210 hPa.

As the Examples, further improvement in polishing rate was seen in Example 3 containing abrasive grains and Example 4 containing a mixture of benzene sulfonates having alkyl groups having different carbon number.

The results regarding polishing rate ratio that is a ratio between polishing rate under low load and polishing rate under high load are shown below.

FIG. 2 is a graph showing polishing rate ratios of Examples 2 to 4 and Comparative Examples 2 and 3.

The vertical axis shows polishing rate ratio [−] which is a ratio between polishing rate under load of 5 hPa and polishing rate under load of 140 hPa (Graph 3) and a ratio between polishing rate under load of 5 hPa and polishing rate under load of 210 hPa (Graph 4).

Regarding Comparative Examples 2 and 3, because polishing rate under low load (5 hPa) is high, polishing rate ratio is as small as 1.1 or 1.4, and load dependency was not seen. Because Examples 2 to 4 had low polishing rate under low load (5 hPa), polishing rate ratio is as large as at least 10 times, and load dependency was seen.

Load dependency greatly affects level-difference elimination properties, and it is known that level-difference elimination properties are excellent and flatness is improved, as load dependency is large (as polishing rate ratio is large). Therefore, it was found that the polishing composition of the invention improved polishing rate, and additionally improved flatness.

Investigations were conducted on the constitution using a compound other than ammonium hydroxide as a basic compound containing an ammonium group.

Examples 5 to 11 have the same composition as Example 1, except for containing ammonium chloride (Example 5), containing ammonium carbonate (Example 6), containing ammonium nitrate (Example 7), containing ammonium sulfate (Example 8), containing ammonium hydrogen carbonate (Example 9), containing ammonium phosphate (Example 10) and containing ammonium pyrophosphate (Example 11), in place of a basic compound containing an ammonium group, respectively.

Using Examples 5 to 11 as above, polishing rate was measured. The polishing conditions and the evaluation method of polishing rate are the same as above. The results are shown in Table 3.

TABLE 3

| | Polishing rate [μm/min] | | Polishing rate ratio [—] |
|---|---|---|---|
| | 5 hPa | 140 hPa | 140 hPa/5 hPa |
| Example 5 | 0.8 | 3.1 | 3.9 |
| Example 6 | 0.7 | 2.8 | 4.0 |
| Example 7 | 1.1 | 3.1 | 2.8 |
| Example 8 | 1.2 | 2.9 | 2.4 |
| Example 9 | 1.0 | 2.4 | 2.4 |
| Example 10 | 0.7 | 3.1 | 4.4 |
| Example 11 | 0.6 | 2.8 | 4.7 |

It was found that in Examples 5 to 11, polishing rate was suppressed very low under the condition that load was 5 hPa, and polishing rate was improved under the condition that load was 140 hPa.

Thus, it was found that even in the case of using various ammonium salts, the polishing composition of the invention had load dependency, improved polishing rate, and improved flatness.

Investigations were conducted on the constitution using compounds other than tartaric acid as an organic acid.

Examples 12 to 18 have the same composition as Example 3, except for containing citric acid (Example 12), containing malic acid (Example 13), containing oxalic acid (Example 14), containing malonic acid (Example 15), containing glycine (Example 16), containing succinic acid (Example 17) and fumaric acid (Example 18), in place of tartaric acid as an organic acid.

Using Examples 12 to 18 as above, polishing rate was measured. The polishing conditions and the evaluation method of polishing rate are the same as above. The results are shown in Table 4.

TABLE 4

| | Polishing rate [μm/min] | | Polishing rate ratio [—] |
|---|---|---|---|
| | 5 hPa | 140 hPa | 140 hPa/5 hPa |
| Example 12 | 1.0 | 6.5 | 6.5 |
| Example 13 | 1.1 | 7.2 | 6.5 |
| Example 14 | 1.2 | 6.2 | 5.2 |
| Example 15 | 0.9 | 5.5 | 6.1 |
| Example 16 | 0.3 | 7.2 | 24.0 |
| Example 17 | 0.7 | 6.8 | 9.7 |
| Example 18 | 0.6 | 6.2 | 10.3 |

It was found that in Examples 12 to 18, polishing rate was suppressed very low under the condition that load was 5 hPa, and polishing rate was improved under the condition that load was 140 hPa.

Thus, it was found that even in the case of using various organic acids, the polishing composition of the invention had load dependency, improved polishing rate, and improved flatness.

Investigations were conducted on the change of dishing amount when the content of alkylbenzene sulfonate was changed.

Examples 19 to 24 have the same composition as Example 4, except changing the content of alkylbenzene sulfonate to 0.05% by weight (Example 19), 0.25% by weight (Example 20), 0.75% by weight (Example 21), 1.0% by weight (Example 22), 1.5% by weight (Example 23) and 2.0% by weight (Example 24), in place of 0.5% by weight.

Comparative Example 4 has the same composition as Example 4, except for not containing alkylbenzene sulfonate.

Using Examples 4 and 19 to 24 and Comparative Example 4 as above, dishing amount was measured. The polishing conditions are the same as above. Polishing load surface pressure is 140 hPa, and 100-mm diameter copper-plated substrate as a substrate to be polished is such that copper wiring having wiring width of 100 μm and depth of 5,000 nm is provided, and copper plating film having a thickness of 10 μm is formed on the whole surface thereof.

### [Dishing Amount]

100-mm diameter copper-plated substrate as a substrate to be polished was polished, and time corresponding to 30% of the time required to expose copper wiring was used as additional polishing time. After confirming that the copper wiring was exposed, polishing was further conducted for only the additional polishing time. After completion of the additional polishing time, depth of recesses formed on the surface of the copper wiring is measured with a stylus profiler (trade name: P12, manufactured by KLA-Tencor Corporation), and the measurement result is used as dishing amount. The measurement results are shown in Table 5.

TABLE 5

| | Content [% by weight] | Dishing amount [nm] |
|---|---|---|
| Comparative Example 4 | 0 | 5000 |
| Example 19 | 0.05 | 3100 |
| Example 20 | 0.25 | 1812 |
| Example 4 | 0.5 | 1400 |
| Example 21 | 0.75 | 920 |
| Example 22 | 1.0 | 300 |
| Example 23 | 1.5 | 300 |
| Example 24 | 2.0 | 290 |

It was found that in Comparative Example 4 which did not contain alkylbenzene sulfonate, dishing amount was 5000 nm and large dishing occurred, whereas in Examples 4 and 19 to 24 which contained alkylbenzene sulfonate, dishing amount was small, and dishing was suppressed from generating. Dishing amount was decreased as the content of alkylbenzene sulfonate was increased, and the dishing amount was not almost changed in the content of from 1.0 to 2.0% by weight.

Evaluation of etching rate was conducted using Example 2 and Comparative Example 2. Evaluation method of etching rate is as follows.

### [Etching Rate]

The etching rate evaluated is a so-called dynamic etching rate in the case where a sample was shaken in a polishing composition.

The sample used was a copper printed substrate of 30 mm×30 mm, and was dipped in the polishing compositions of Example 2 and Comparative Example 2 for dipping time in liquid of 60 seconds under the shaking conditions of shaking width of 23 mm and frequency of 2.2 Hz.

Decrease in thickness by etching was calculated from thickness of copper foil before dipping in a polishing composition and thickness of copper foil after dipping therein.

It was found that etching rate of Comparative Example 2 was 6.5 μm/min, whereas that of Example 2 was 2.2 μm/min, and thus, the etching rate was suppressed.

Evaluation was conducted on surface smoothness as other evaluation using Examples 1 to 24 and Comparative Examples 1 to 3.

The surface smoothness was evaluated by visually observing the surface of a copper foil after polishing under the above-described polishing conditions using the respective polishing compositions.

As to all of Comparative Examples 1 to 3, the surface of a copper foil after polishing was in a dulling state, and mirror portion was not observed. In contrast, it was found that as to all of Examples 1 to 24, the surface of a copper foil was in a mirror state and was sufficiently smoothened.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### INDUSTRIAL APPLICABILITY

According to the invention, there is provided a polishing composition comprising a basic compound containing an ammonium group, alkylbenzene sulfonate having an alkyl group with carbon number of from 9 to 18, and hydrogen peroxide.

Polishing rate under low load is low, polishing rate under high load is high, level-difference elimination properties in wiring part is excellent as a ratio of the respective polishing rates is increased, that is, as load dependency is increased, and flatness is improved.

In the invention, by making the composition as above, not only high polishing rate is achieved, but load dependency can be increased, thereby flatness can be improved.

According to the invention, the polishing composition has a pH of from 8 to 12, and it is preferred to be used in alkaline state. Where the polishing composition has a pH smaller than 8, polishing rate is decreased, and where the polishing composition has a pH exceeding 12, etching rate of copper is increased and flatness is deteriorated.

According to the invention, as the basic compound containing an ammonium group, one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate.

According to the invention, it is more preferred that the carbon number of an alkyl group in alkylbenzene sulfonate is from 10 to 16.

According to the invention, polishing rate can further be improved by containing abrasive grains.

According to the invention, further improvement can be achieved by containing an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid.

1. A polishing composition comprising:
a basic compound containing an ammonium group;
alkylbenzene sulfonate having an alkyl group with carbon number of from 9 to 18; and
hydrogen peroxide.

2. The polishing composition of claim 1, wherein the polishing composition has a pH of from 8 to 12.

3. The polishing composition of claim 1, wherein the basic compound containing an ammonium group is one or two or more selected from among ammonium hydroxide, ammonium chloride, ammonium carbonate, ammonium nitrate, ammonium sulphate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate.

4. The polishing composition of claim 1, wherein the carbon number of the alkyl group in the alkylbenzene sulfonate is from 10 to 16.

5. The polishing composition of claim 1, comprising abrasive grains.

6. The polishing composition of claim 1 comprising an organic acid of one or two or more selected from among tartaric acid, citric acid, malic acid, ethylenediaminetetraacetic acid, oxalic acid, malonic acid, nicotonic acid, valeric acid, ascorbic acid, adipic acid, pyruvic acid, glycine, succinic acid and fumaric acid.

7. The polishing composition of claim 2, wherein the carbon number of the alkyl group in the alkylbenzene sulfonate is from 10 to 16.

8. The polishing composition of claim 3, wherein the carbon number of the alkyl group in the alkylbenzene sulfonate is from 10 to 16.

9. The polishing composition of claim 2, comprising abrasive grains.

10. The polishing composition of claim 3, comprising abrasive grains.

11. The polishing composition of claim 4, comprising abrasive grains.

12. The polishing composition of claim 2 comprising an organic acid of one or two or more selected from among tartaric acid, citric acid, malic acid, ethylenediaminetetraacetic acid, oxalic acid, malonic acid, nicotonic acid, valeric acid, ascorbic acid, adipic acid, pyruvic acid, glycine, succinic acid and fumaric acid.

13. The polishing composition of claim 3 comprising an organic acid of one or two or more selected from among tartaric acid, citric acid, malic acid, ethylenediaminetetraacetic acid, oxalic acid, malonic acid, nicotonic acid, valeric acid, ascorbic acid, adipic acid, pyruvic acid, glycine, succinic acid and fumaric acid.

14. The polishing composition of claim 4 comprising an organic acid of one or two or more selected from among tartaric acid, citric acid, malic acid, ethylenediaminetetraacetic acid, oxalic acid, malonic acid, nicotonic acid, valeric acid, ascorbic acid, adipic acid, pyruvic acid, glycine, succinic acid and fumaric acid.

15. The polishing composition of claim 5 comprising an organic acid of one or two or more selected from among tartaric acid, citric acid, malic acid, ethylenediaminetetraacetic acid, oxalic acid, malonic acid, nicotonic acid, valeric acid, ascorbic acid, adipic acid, pyruvic acid, glycine, succinic acid and fumaric acid.
